(19) United States
(12) Patent Application Publication
(10) Pub. No.: US 2004/0110045 A1
(43) Pub. Date: Jun. 10, 2004

(54) Method for preparing standby gas for a fuel cell arrangement

(76) Inventors: Stefan Rolf, Munchen (DE); Stefan Ibrahim Peterhans, Bad Tolz (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/467,515

(22) PCT Filed: Feb. 8, 2002
(86) PCT No.: PCT/EP02/01316

(30) Foreign Application Priority Data
Feb. 10, 2001 (DE) 101 06 220.6

(51) Int. Cl. H01M 8/06; C01B 31/20

(52) U.S. Cl. 429/17; 429/19; 423/437.1

(57) ABSTRACT

A method is described for providing standby gas for a fuel cell arrangement, and the corresponding fuel cell arrangement itself is described. According to the invention, it is provided that a combustible gas is mixed with air or another oxygen-containing gas to form a first mixture and is guided through a first catalyst device (7, 8), the standby gas being obtained while converting the oxygen fraction of the first gas mixture to carbon dioxide and water vapor and while converting constituents of water vapor and higher hydrocarbons contained in the gas mixture to methane and hydrogen. The combustible gas is preferably mixed with air or another oxygen-containing gas to form a first mixture (5) and is guided at a defined first temperature through a first catalyst (7), a second gas mixture being obtained while converting the oxygen fraction of the first gas mixture to carbon dioxide and water vapor. The second gas mixture is guided at a defined second temperature through a second catalyst (8), the standby gas being obtained while converting constituents of water vapor and higher hydrocarbons contained in the gas mixture to methane and hydrogen.

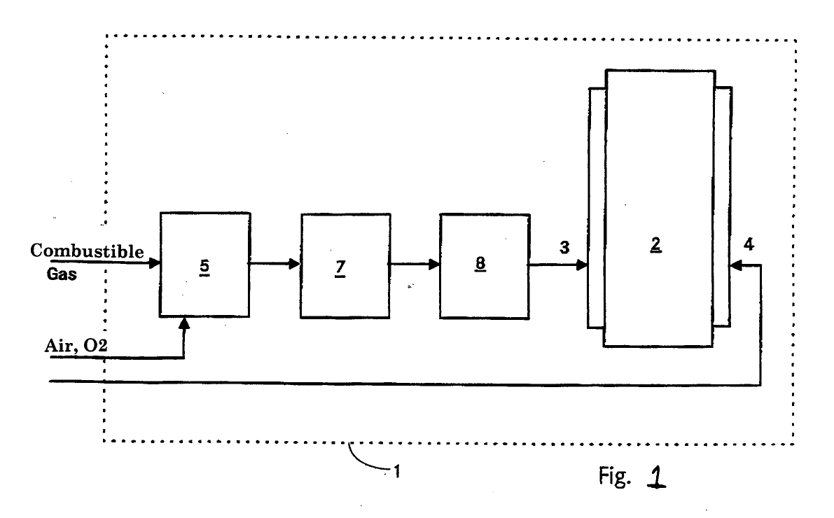

The invention relates to a method of providing standby gas for a fuel cell arrangement.

During the operation of fuel cell arrangements, particularly of those in which molten carbonate fuel cells are used, it is one requirement that the operating temperature is to be maintained during system disturbance and maintenance periods. In the case of molten carbonate fuel cells, this means that an operating temperature of approximately 650° C. is to be maintained. For preventing oxidations on the anode side, that is, on the anodes typically made of nickel, it is required in this case to feed a flush gas to the anodes, which flush gas typically consists of nitrogen, hydrogen and/or carbon dioxide. Conventionally, flush gases or standby gases are stored on the fuel cell arrangement especially for this purpose. This leads to an increased investment and surface requirement and limits the permissible stoppage time to the range of the flush gas supply.

From Japanese Patent Abstract 04004570 A, a fuel cell arrangement is known in which a standby gas consisting mainly of hydrogen is used for overcoming stoppage times of the fuel cell arrangement while maintaining the fuel cell temperature. Furthermore, from Japanese Patent Abstract 04324253 A, a fuel cell arrangement is known in which a standby gas is used which consists of nitrogen mixed with a reducing gas in order to prevent an oxidation of the anodes of the fuel cell arrangement during stoppage times of the fuel cell arrangement.

It is an object of the invention to indicate a method of providing standby gas for a fuel cell arrangement, in the case of which the standby gas does not have to be especially stored. Furthermore, by means of the invention, a fuel cell arrangement is to be indicated which has devices for providing standby gas, in the case of which the standby gas does not have to be stored specifically for this purpose.

With respect to the method, the object is achieved by means of the method indicated in Claim 1. Advantageous further developments of the method according to the invention are indicated in Claims 2 to 12.

With respect to the device, the object is achieved by means of the device indicated in Claim 13. Advantageous further developments of the device according to the invention are indicated in Claims 14 to 20.

With respect to the method, the object is achieved by means of a method of providing standby gas for a fuel cell arrangement, particularly a molten carbonate fuel cell arrangement. According to the invention, it is provided that a combustible gas is mixed with air or another oxygen-containing gas to form a first mixture and is guided through a catalyst device, the standby gas being obtained while converting the oxygen fraction of the first gas mixture to carbon dioxide and water vapor, and while converting constituents of water vapor and higher hydrocarbons contained in the gas mixture to methane and hydrogen.

A significant advantage of the method according to the invention is that the use of large-volume storage tanks for providing standby gases can be eliminated, which reduces the maintenance and operating costs of the fuel cell arrangement. It is also advantageous that the duration of the permissible stoppage times is not restricted by the size of a limited supply of standby gas.

According to a very advantageous embodiment of the invention, it is provided that the first mixture is guided through a first catalyst at a defined first temperature, in which case, while converting the oxygen fraction of the first gas mixture to carbon dioxide and water vapor, a second gas mixture is obtained, and that the second gas mixture is guided through a second catalyst at a defined second temperature, in which case the standby gas is obtained while converting constituents of water vapor and higher hydrogen carbons contained in the gas mixture to methane and hydrogen, the conversion of the second gas mixture taking place endothermally at an increased temperature.

According to an advantageous embodiment of the invention, it is provided that the air or the oxygen-containing gas is fed understoichiometrically, so that a small constituent of combustible gas is contained in the obtained standby gas.

According to an advantageous embodiment of the invention, it is provided that, for producing the standby gas, first the peak load gas is catalytically converted to combustible gas.

According to an advantageous further development thereof, it is provided that the catalytic conversion of the peak load gas to combustible gas takes place for producing the standby gas corresponding to the reaction equation

10 C3H8+85 CH4+5 O2=9 C3H8+85 CH4+3 CO2+4 H2O

According to another advantageous embodiment of the invention, it is provided that, for producing the standby gas, combustible gas is catalytically converted. According to an advantageous further development thereof, it is provided that the catalytic conversion of the combustible gas to standby gas takes place corresponding to the reaction equation

12 CH4+20 O2+80 N2+10 CO2+2 CH4+20 H2O

According to an advantageous further development of the invention, it is provided that a conventional combustion catalyst is used for converting the first gas mixture.

According to another advantageous embodiment of the invention, it is provided that a conventional combustion catalyst is used as the second catalyst for converting the second gas mixture.

Advantageously, the standby gas is fed to the anode side of the fuel cell arrangement.

It is also advantageous that the fuel cell arrangement is maintained at the operating temperature in the stoppage operation by the feeding of the standby gas.

According to an advantageous further development of the invention, it is provided that a liquid gas is used as the combustible gas from which the standby gas is produced.

With respect to the device, the object is achieved by means of a fuel cell arrangement, particularly a molten carbonate fuel cell arrangement, having one or more fuel cells which each have an anode and cathode, and having a combustible gas inlet for feeding a combustible gas to the anodes, and a cathode inlet for feeding a cathode gas to the cathodes, as well as having a catalyst device for the catalytic processing of the combustible gas.

According to the invention, it is provided that device are provided for mixing a combustible gas with air or another oxygen-containing gas to form a first mixture, and that the catalyst device is provided for obtaining the standby gas while converting the oxygen fraction to carbon dioxide and water vapor and while converting constituents of water vapor and higher hydrocarbons contained in the gas mixture to methane and hydrogen.

It is an important advantage of the fuel cell arrangement according to the invention that the use of large-volume storage tanks for providing standby gases can be eliminated, which reduces the maintenance and operating costs of the fuel cell arrangement. It is another advantage that the duration of the permissible stoppage times is not restricted by the size of a limited supply of standby gas. Finally, it is advantageous that catalyst devices already existing in the fuel cell arrangement, which are provided for the operation with peak load gas, can be used for producing the standby gas.

According to an advantageous further development of the invention, devices are provided for mixing a combustible gas with air or another oxygen-containing gas to form a first mixture, and the catalyst device contains a first catalyst, through which the first mixture is guided at a defined first temperature, in which case a second gas mixture is obtained while converting the oxygen fraction of the first gas mixture to carbon dioxide and water vapor, and the catalyst device contains a second catalyst, through which the second gas mixture is guided at a defined second temperature, in which case the standby gas is obtained while converting constituents of water vapor and higher hydrocarbons contained in the gas mixture to methane and hydrogen, and in which case the conversion of the second gas mixture in the second catalyst takes place endothermally at an increased temperature.

According to another advantageous further development of the invention, it is provided that the air or the oxygen-containing gas is fed understoichiometrically, so that a small constituent of combustible gas is contained in the obtained standby gas.

According to an advantageous further development of the invention, it is provided that peak load gas is fed to the first catalyst for the catalytic conversion to combustible gas.

According to another advantageous further development of the invention, it is provided that combustible gas is fed to the second catalyst for the catalytic conversion to standby gas.

According to another advantageous further development of the invention, it is provided that a conventional combustion catalyst is used as a first catalyst for the conversion of the first gas mixture.

According to another advantageous further development of the invention, it is provided that a conventional combustion catalyst is used as the second catalyst for converting the second gas mixture.

Finally, it is provided according to an advantageous embodiment of the invention that the standby gas is fed to the anode side of the fuel cell arrangement.

In the following, an embodiment of the invention with respect to the device and the method is described by means of the FIGURE.

The FIGURE shows a block diagram of a fuel cell arrangement according to an embodiment of the invention in which the method according to the invention as well as the device according to the invention for providing standby gas for a fuel cell arrangement are implemented.

In the FIGURE, Reference Number 1 indicates a fuel cell arrangement, particularly a molten carbonate fuel cell arrangement, which comprises one or more fuel cells 2. The fuel cells 2 each contain an anode and a cathode which are not specifically shown in the FIGURE. Furthermore, the fuel cell arrangement 1 comprises a combustible gas inlet 3 for feeding a combustible gas to the anodes, and a cathode inlet 4 for feeding a cathode gas to the cathodes of the fuel cells 2. A catalyst device 7, 8 is provided for the catalytic processing of the combustible gas. The catalyst device 7, 8 may particularly also be used for the catalytic processing of the combustible gas from a peak load gas.

Devices 5 are provided for mixing a combustible gas with air or another oxygen-containing gas to form a first mixture.

In the illustrated embodiment, the catalyst device 7, 8 contains a first catalyst 7, through which the first mixture is guided at a defined first temperature. In the first catalyst 7, a second gas mixture is obtained while converting the oxygen fraction while the oxygen fraction of the first gas mixture is converted to carbon dioxide and water vapor. The catalyst device 7, 8 contains a second catalyst 8 through which the second gas mixture is guided at a defined second temperature. In the second catalyst 8, the standby gas is obtained while converting constituents of water vapor and higher hydrocarbons contained in the gas mixture to methane and hydrogen.

The conversion of the second gas mixture in the second catalyst 8 takes place endothermally at an increased temperature.

The air or the oxygen-containing gas is understoichiometrically fed so that a small constituent of combustible gas is contained in the obtained standby gas.

In the embodiment described here, peak load gas is fed to the first catalyst 7 for the catalytic conversion to combustible gas. The catalytic conversion of the peak load gas to combustible gas for producing the standby gas takes place corresponding to the reaction equation

10 C3H8+85 CH4+5 O2=9 C3H8+85 CH4+3 CO2+4 H2O

The catalytic conversion of the combustible gas to standby gas in the second catalyst 8 takes place corresponding to the reaction equation

12 CH4+20 O2+80 N2+10 CO2+2 CH4+20 H2O

A conventional combustion catalyst can be used as a first catalyst 7 for converting the first gas mixture. Likewise, a conventional combustion catalyst can be used as a second catalyst for converting the second gas mixture.

The thus produced standby gas is fed to the anode side at the combustible-gas inlet 3 of the fuel cell arrangement 1.

The fuel cell arrangement 1 is maintained at the operating temperature in the stoppage operation by feeding the standby gas.

Liquid gas can be used as the combustible gas from which the standby gas is produced.

1. Method for producing standby gas for a fuel cell system, especially a molten carbonate fuel cell system, characterized in that a combustible gas is mixed with air or some other oxygen-containing gas into a first mixture and fed through a catalytic device, whereby the standby gas is obtained under the conversion of the portion of oxygen in the first gas mixture to carbon dioxide and steam, and under the conversion of components of steam and higher hydrocarbons contained in the gas mixture to methane and hydrogen, and whereby in the standby gas that is produced, a small component of combustible gas is contained due to the fact that the air or the oxygen-containing gas is added hypostoichiometrically.

2. Method according to claim 1, characterized in that the first mixture is fed at a specified first temperature through a first catalyst, whereby a second gas mixture is obtained under the conversion of the portion of oxygen in the first gas mixture to carbon dioxide and steam, and in that the second gas mixture is fed at a specified second temperature through a second catalyst, whereby the standby gas is obtained during the conversion of the constituents of steam and higher hydrocarbons contained in the gas mixture to methane and steam, whereby the conversion of the second gas mixture takes place endothermically at an increased temperature, and whereby a small component of combustible gas is contained in the standby gas that is produced, due to the fact that the air or the oxygen-containing gas is added hypostoichiometrically.

3. Method according to claim 1 or 2, characterized in that oxygen-containing peak-load gas is first catalytically converted to oxygen-free combustible gas to produce the standby gas.

4. Method according to claim 3, characterized in that the catalytic conversion of the peak-load gas to combustible gas for the production of the standby gas follows in accordance with the chemical equation
10 C3H8+85 CH4+5 O2=9 C3H8+85 CH4+3 CO2+4 H2O.

5. Method according to one of claims 1 through 4, characterized in that combustible gas is catalytically converted to produce the standby gas.

6. Method according to claim 5, characterized in that the catalytic conversion of the combustible gas to standby gas follows in accordance with the chemical equation
12 CH4+20 O2+80 N2=80 N2+10 CO2+2 CH4+20 H2O.

7. Method according to one of the claims 1 through 6, characterized in that a conventional combustion catalyst is used as the first catalyst in converting the first gas mixture.

8. Method according to one of the claims 1 through 7, characterized in that a conventional combustion catalyst is used as the second catalyst in converting the second gas mixture.

9. Method according to one of the claims 1 through 8, characterized in that the standby gas is fed to the anode side of the fuel cell system.

10. Method according to claim 9, characterized in that, as a result of the addition of the standby gas, the fuel cell system is held in standstill operation at operating temperature.

11. Method according to one of claims 1 through 10, characterized in that liquid gas is used as the combustible gas from which the standby gas is produced.

12. Device for producing standby gas in standstill operation for a fuel cell system, especially a molten carbonate fuel cell system, with one or more fuel cells (2), which in each case have one anode and one cathode, and with a combustible gas intake (3) for supplying a combustible gas to the anodes and a cathode intake (4) for supplying a cathode gas to the cathodes, characterized in that the device for producing standby gas comprises a means (5) for mixing a combustible gas with air or some other oxygen-containing gas to form a first mixture, and a catalyst unit (7, 8), both of which lie in the combustible gas supply line to the combustible gas intake (3), and in that the catalyst unit (7, 8) is provided for producing a standby gas, under the conversion of the portion of oxygen to carbon dioxide and steam and under the conversion of constituents of steam and higher hydrocarbons contained in the gas mixture to methane and hydrogen, in which standby gas a small constituent of combustible gas is contained.

13. Device according to claim 12, characterized in that the catalyst unit (7, 8) contains a first catalyst (7), through which the first mixture is fed at a specified first temperature, whereby a second gas mixture is obtained during the conversion of the portion of oxygen in the first gas mixture to carbon dioxide and steam, and in that the catalyst unit (7, 8) contains a second catalyst (8), through which the second gas mixture is fed at a specified second temperature, wherein the standby gas is produced during the conversion of the constituents of steam and higher hydrocarbons contained in the gas mixture to methane and hydrogen, and whereby the conversion of the second gas mixture takes place in the second catalyst (8) endothermically at an increased temperature.

14. Device according to claim 12 or 13, characterized in that a conventional combustion catalyst is used as the first catalyst (7) for converting the first gas mixture.

15. Device according to claim 13, characterized in that a conventional combustion catalyst is used as the second catalyst (8) for converting the second gas mixture.
